(19) United States
(12) Patent Application Publication
(10) Pub. No.: US 2015/0199429 A1
(43) Pub. Date: Jul. 16, 2015

(54) AUTOMATIC GEO METADATA GATHER BASED ON USER'S ACTION

(71) Applicant: Lenovo Enterprise Solutions (Singapore) Pte. Ltd., New Tech Park (SG)

(72) Inventors: Barry A. Kritt, Raleigh, NC (US); Sarbajit K. Rakshit, Kolkata (IN)

(21) Appl. No.: 14/154,721

(22) Filed: Jan. 14, 2014

(51) Int. Cl. G06F 17/30

(52) U.S. Cl. CPC G06F 17/30864; G06F 17/30241

(57) ABSTRACT

Provided are techniques for gathering geo-metadata corresponding to a plurality of locations; correlating each datum of the geo-metadata with a particular location of the plurality of locations; storing in conjunction with each particular datum information identifying the particular location correlated to each particular datum to produce a location/geo-metadata information source; mining the geo-metadata information source to generate a plurality of patterns associated with the plurality of locations; and searching the plurality of patterns in response to a query for information to produce an answer to the query.

### FIELD OF DISCLOSURE

The claimed subject matter relates generally to geo-metadata and, more specifically, to techniques for gathering user information as geo-metadata corresponding to a location.

### BACKGROUND OF TUE INVENTION

With the proliferation of social networking and the devices associated with social networking, people typically share information about places such as, but not limited to, restaurants, shopping centers, coffee shops, clubs, movie theaters and so on. Such information may provide recommendations on points of interest (POI), routes, menu items and many other attributes. Recommendations and reviews also provide information on various locations.

### SUMMARY

Provided are techniques for gathering information about users' actions and then associating the user information with locations as geo-metadata corresponding to the locations. Users' actions may be, for example, a photographic click, an average time to take a photograph, the sharing of a photograph, an average time spent in a particular location, a number of items purchased, a movie watched and so on. The gathered data is then associated with the location at which the action took place. Based upon the gathered data, an ontology may be extracted and the geo-metadata may be categorized for future data query. For example, a user may query the geo-metadata to find a restaurant at which other users have typically spent between one and two hours. In other words, a user may execute a query to locate, independently of any recommendation or review, a restaurant that is comfortable to spend time talking.

Provided are techniques for gathering geo-metadata corresponding to a plurality of locations; correlating each datum of the geo-metadata with a particular location of the plurality of locations; storing in conjunction with each particular datum information identifying the particular location correlated to each particular datum to produce a location geo-metadata in formation source; mining the geo-metadata information source to generate a plurality of patterns associated with the plurality of locations; and searching the plurality of patterns in response to a query for information to produce an answer to the query.

This summary is not intended as a comprehensive description of the claimed subject matter but, rather, is intended to provide a brief overview of some of the functionality associated therewith. Other systems, methods, functionality, features and advantages of the claimed subject matter will be or will become apparent to one with skill in the art upon examination of the following figures and detailed description.

### BRIEF DESCRIPTION OF THE DRAWINGS

A better understanding of the claimed subject matter can be obtained when the following, detailed description of the disclosed embodiments is considered in conjunction with the following figures, in which:

FIG. 1 is a computing and communication architecture that may implement the claimed subject matter.

FIG. 2 is a block diagram of a Geo-metadata Gather and Organization apparatus (GMGO) that implements aspects of the claimed subject matter

FIG. 3 is a flowchart of one example of a Gather Geo-metadata process that may implement aspects of the claimed subject matter.

FIG. 4 is an example of a flowchart of a Organize Geo-metadata process that may implement aspects of the claimed subject matter.

FIG. 5 is an example of a flowchart of a Query Geo-metadata process that may implement aspects of the claimed subject matter.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable. RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational actions to be performed on the computer, other programmable apparatus or other devices to produce a computer implemented process such that the instructions which execute on the computer or other programmable apparatus provide processes for implementing the functions/acts specified in the flowchart and/or block diagram block or blocks.

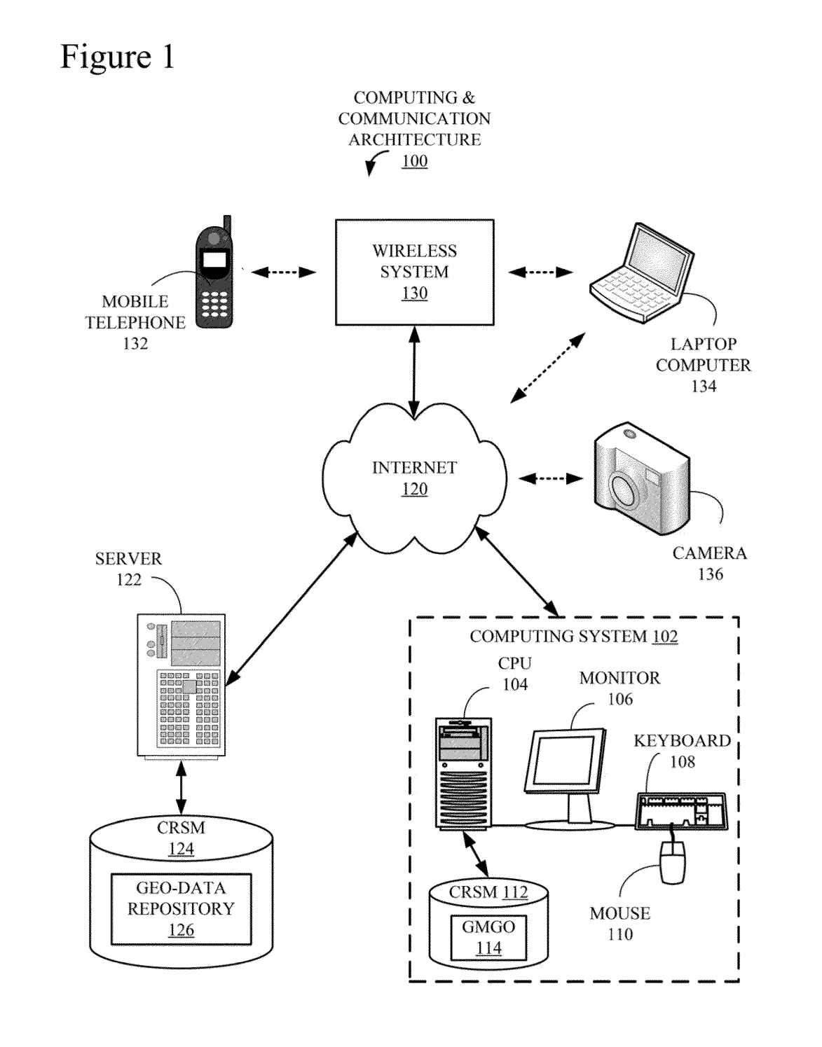

Turning now to the figures. FIG. 1 is an example of a computing and communication architecture 100 that may implement the claimed subject matter. A computing system 102 includes a central processing unit (CPU) 104, coupled to a monitor 106, a keyboard 108 and a pointing device, or “mouse,” 110, which together facilitate human interaction with other components of architecture 100 and computing system 102. Also included in computing system 102 and attached to CPU 104 is a computer-readable storage medium (CRSM) 112, which may either be incorporated into computing system 102, i.e. an internal device, or attached externally to CPU 104 by means of various, commonly available connection devices such as but not limited to, a universal serial bus (USB) port (not shown).

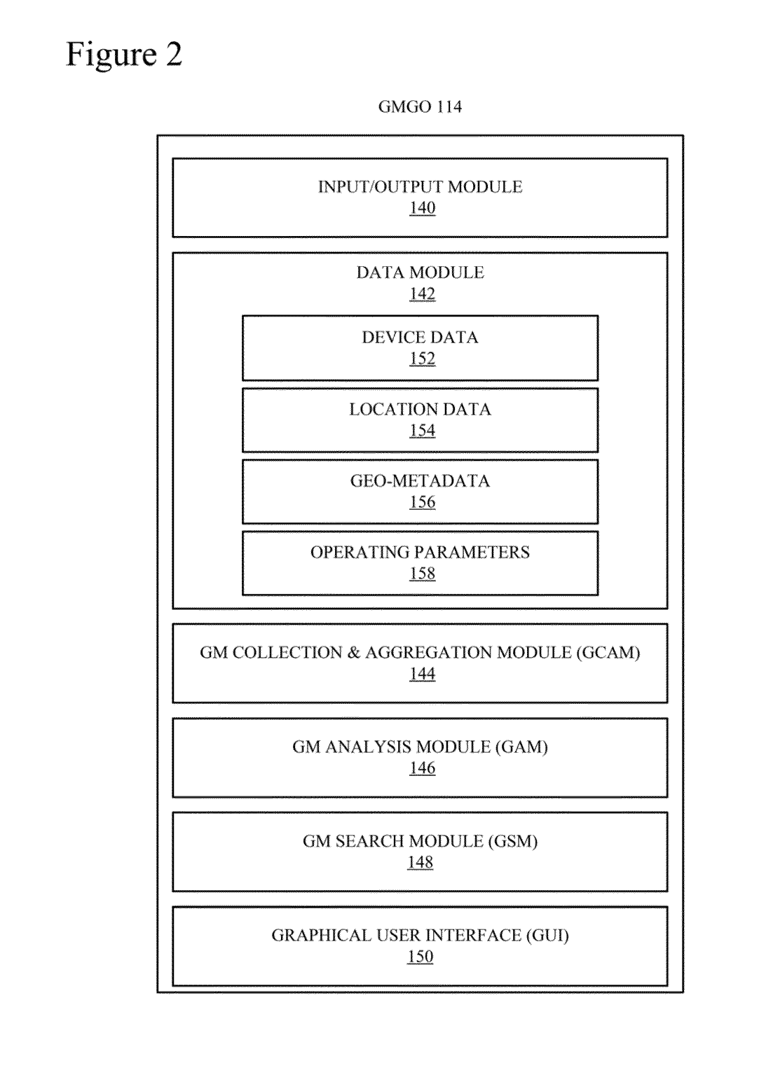

CRSM 112 is illustrated storing a Geo-metadata Gather and Organization apparatus (GMGO) 114 that incorporates aspects of the claimed subject matter. In the following examples, logic associated with GMGO 114 is executed on one or more processors (not shown) of CPU 104. GMGO 114 represents device that collects. aggregates and organizes geo-metadata in accordance with the disclosed technology and is described in more detail below in conjunction with FIGS. 2-5. It should be noted that most computing systems and architectures would typically include more components and applications, but for the sake of simplicity a few are illustrated.

Computing system 102 and CPU 104 are connected to the Internet 120, which is also connected to a server computer, or simply “server,” 122. Although in this example, computing system 102 and server 122 are communicatively coupled via the Internet 120, they could also be coupled through any number of communication mediums such as, but not limited to, a local area network (LAN) not shown). Coupled to server 122 is a CRSM 124, which stores a geo-data repository 126, used for illustrative purposes. In the following example, geo-data 126 represents geo-data, which may be publically available, which the claimed subject matter can utilize. In this manner, GMGO 114 does not have to duplicate the many available stores of geo-data but can rather augment them by providing additional searching capabilities. Also attached to the Internet 120 is a wireless system 130. Wireless system 130 may be, but is not limited to, a cellular telephone network, a Wi-Fi network or any other existing or yet to be developed communication system. Coupled to wireless system 130 are a mobile telephone 132 and a mobile computing device, or laptop computer, 134. Coupled to the Internet 120 are laptop computer 134 and a camera 136. Mobile telephone 132, mobile computer 134 and camera 136 are merely examples of devices that may transmit geo-data to GMGO 114 to implement the claimed subject matter. Additional devices may include, but are not limited to, global positioning system (GPS) devices (not shown), video cameras (not shown) and tablet computers (not shown). In the following description, computing system 102 and mobile telephone 132 are primarily used as the examples. It should be noted there are many possible computing and communication configurations, of which architecture 100 and computing system 102 are only simple examples.

FIG. 2 is a block diagram of GMGO 114, introduced above in FIG. 1, in greater detail. GMGO 114 includes an input/output (I/O) module 140, a data module 142, a geo-metadata (GM) collection and aggregation module (GCAM) 144, a GM Analysis module (GCAM) 146, a GM Search Module (GSM) 148 and a graphical user interlace (GUI) 150. For the sake of the following examples, GMGO 114 is assumed to be associated with logic stored on CRSM 112 (FIG. 1) and execute on one or more processors (not shown) of computing system 102 (FIG. 1). It should be understood that the claimed subject matter can be implemented in many types of computing systems and data storage structures but, for the sake of simplicity, is described only in terms of computing system 102 and architecture 100 (FIG. 1). Further, the representation of GMGO 114 in FIG. 2 is a logical model. In other words, components 140, 142, 144, 146, 148 and 150 may be stored in the same or separates files and loaded and/or executed within system 100 either as a single system or as separate processes interacting via any available inter process communication (IPC) techniques.

I/O module 140 handles any communication GMGO 114 has with other components of architecture 100 and computing system 102. Data module 142 is a data repository for information that GMGO 114 requires during normal operation. Examples of the types of information stored in data module 142 include device data 152, location data 154, geo-metadata data 156 and operating parameters 158. Device data 152 stores information on types of devices, such as, but not limited to, mobile telephone 132 (FIG. 1), mobile computer 134 (FIG. 1) and camera 136 (FIG. 1), that may be utilized in accordance with the claimed subject matter. Devices such as devices 132, 134 and 136 may each have their own specific image and geo-metadata formats. Device data 152 enables GMGO 114 to identify and normalize the different types of geo-metadata. Location data 154 stored information to identify the specific geographical locations that have been identified and for which geo-metadata has been collected in accordance with the claimed subject matter. Location data 154 may also provide information that identifies available sources of geo-data such as geo-data repository 126 (FIG. 1).

Geo-metadata 156 stores geo-metadata collected in accordance with the churned subject matter, typically indexed so that the data may be search with respect to location data 154 or geo-data 156. In other words, geo-metadata stores both geo metadata that has been collected and indexes to the corresponding geo-data that is available. Although the illustrated configuration shows geo-data stored remotely, it should be understood that geo-data may also be stored locally on computing system 102. Operating parameters 158 stores information on various user preferences that have been set to control the operation of GMGO 114. For example, operating parameters 158 may store parameters the control the searching and indexing of device data 152, location data 154 and geo-metadata 156 and well as the location of log files.

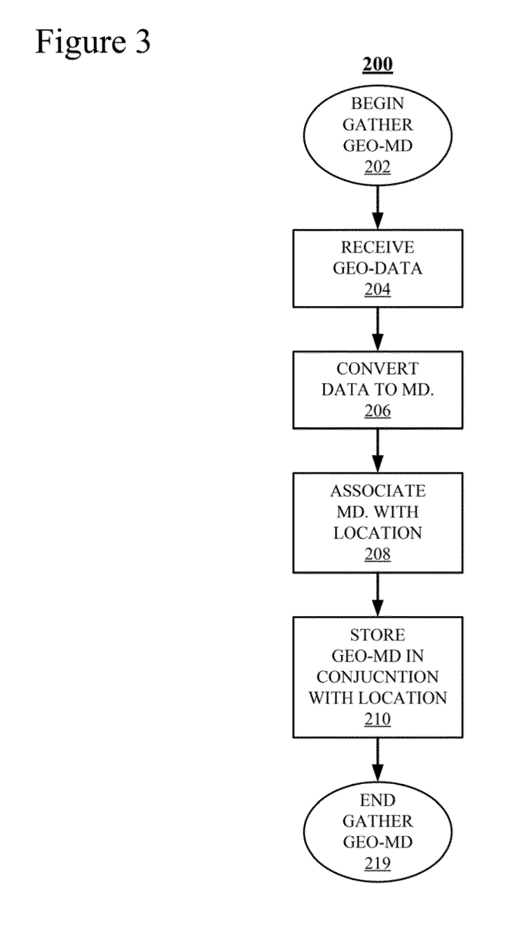

GCAM 144 is responsible for the collection and normalization of geo-metadata in accordance with the disclosed technology. GAM 146 is responsible for the analysis of data processed by GCAM 144. Such analysis may include, but is not limited to, the correlation of received data with specific elements of geo-data such as location data 154 and geo-data 156. GSM 148 is responsible for the parsing of requests for information in accordance with the disclosed technology. GUI 150 enables users or administrators of GMGO 114 to interact with and to define the desired functionality of GMGO 114, typically be the setting of elements of operating parameters 158. Components 142, 144, 146, 148, 150, 152, 154, 156 and 158 are described in more detail below in conjunction with FIGS. 3-5.

FIG. 3 is a flowchart of one example of a Gather Geo-metadata process 200 that may implement aspects of the claimed subject matter. In this example, process 200 is associated with logic stored on CRSM 112 (FIG. 1) in conjunction with GCAM 144 (FIG. 2) of GMGO 114 (FIGS. 1 and 2) and executed on one or more processors (not shown) of CPU 104 (FIG. 1) of computing system 102 (FIG. 1). It should be understood that logic associated with process 200 may also be stored and executed on other devices such as, but not limited to, mobile telephone 132 (FIG. 1), mobile computer 124 (FIG. 1) and camera 136 (FIG. 1).

Process 200 starts in a “Begin Gather Geo-Metadata (GEO-MD)” block 202 and proceeds immediately to a “Receive Geo-Data” block 204. During processing associated with block 204, geo-data is received at GMGO 114 from a mobile device such as, but not limited to, devices 132, 134 and 136 (see 144, FIG. 2). In other words, complementary processes on devices 132, 134 and 136 are configured to collect data on the location of device. Examples of such data include, but are not limited to, location where a photograph is taken, a number of photographs taken, the sharing of a photograph, the time spent in a particular place and the time spent in a particular area. Each datum is also typically associated with a location, which may be determined by any known method, such as geo position system (GPS) information. Typically, such data would be collected by a device in use by an individual whom has signed up for a service provided in accordance with the claimed subject matter. The individual may be required to agree to the collection, aggregation and analysis of the data. In addition, privacy safeguards may be instituted to insure that any data so collected may not be attributed to any particular individual.

During processing associated with a “Convert Data to Metadata” block 206, the data collected during processing associated with block 204 is analyzed to determine any geo-metadata aspects of the data. In addition, the data may be normalized such that different formats from different devices (see 150, FIG. 2) are convened into a single format for storage and processing. During processing, associated with an “Associate MD with Location” block 208, the converted geo-metadata is associated with a location based upon the location data (see 152, FIG. 2) (see 146, FIG. 2). For example, particular location data may be associated with a particular restaurant or movie theater.

During processing associated with a “Store Geo-MD in Conjunction with Location” block 210, the metadata generated during processing associated with block 208 is stored in conjunction with information to correlate it with the location identified during processing associated with block 208. Finally, control proceeds to an “End Gather GEO-MD” block 219 during which process 200 is complete.

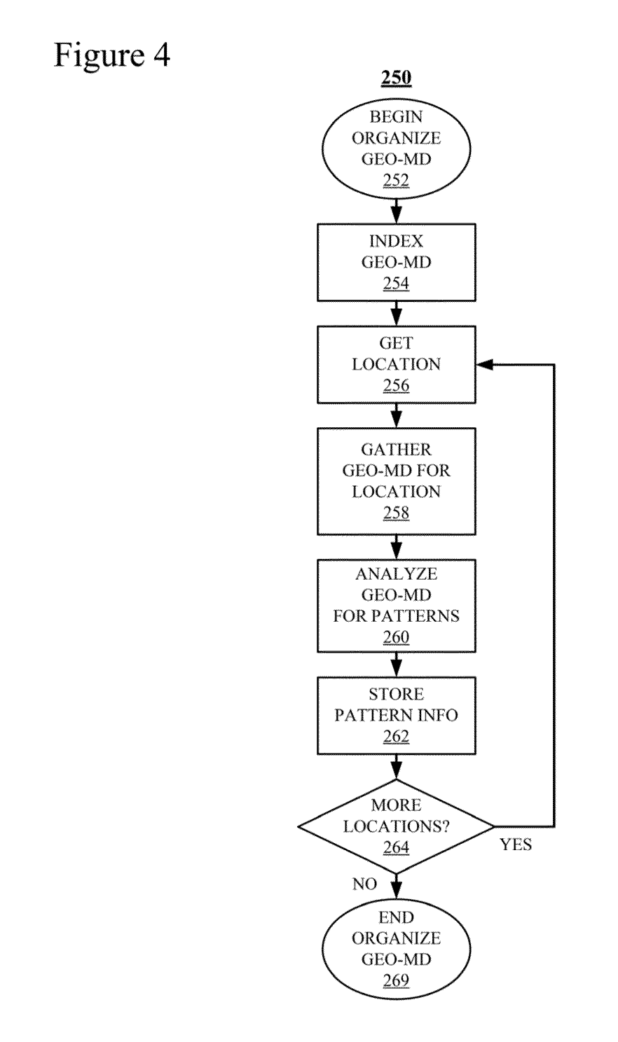

FIG. 4 is an example of a flowchart of a Organize Geo-metadata process 250 that may implement aspects of the claimed subject matter. In this example, process 250 is associated with logic stored on CRSM 112 (FIG. 1) in conjunction with GAM 146 (FIG. 2) of GMGO 114 (FIGS. 1 and 2) and executed on one or more processors (not shown) of CPU 104 (FIG. 1) of computing system 102 (FIG. 1).

Once enough data has been collected, in accordance with process 200, specific patterns may emerge, patterns that may be identified by process 250. Process 250 starts in a “Begin Organize Geo-Metadata (GEO-MD)” block 252 and proceeds immediately to a “Index Geo-MD” block 254. During processing associated with block 254, the data collected in accordance with the claimed subject matter (see 200, FIG. 3) is indexed so that searching and data mining may be more efficient. During processing associated with a “Get Location” block 256, as specific location (see 208, FIG. 3) is selected for processing. During processing associated with a “Gather Metadata for Location” block 258, all the geo-metadata for the location selected during processing associated with block 256 is gathered for processing.

During processing associated with an “Analyze Geo-MD for Patterns” block 260, the data gathered during processing, associated with block 258 is organized according to the type of metadata to facilitate the identification, or “mining,” of patterns (see 146, FIG. 2). For example, an average amount of time spent at a particular restaurant may be determined and perhaps even broken down into the time spent in a waiting area and the time actually spent by the average customer at a table. Such data could also be analyzed based upon the time of day and day of week to determine a best time to patronize the restaurant. If the location is restaurant, a long amount of time may indicate either slow service or a comfortable environment to converse with friends. If the location is a museum, a short average duration may indicate that the museum does not have much to interest the average patron. Such information may be of interest to a potential patron. During processing associated with a “Store Pattern Information (Info)” block 262, the patterns minded during processing associated with block 260 are stored for future reference.

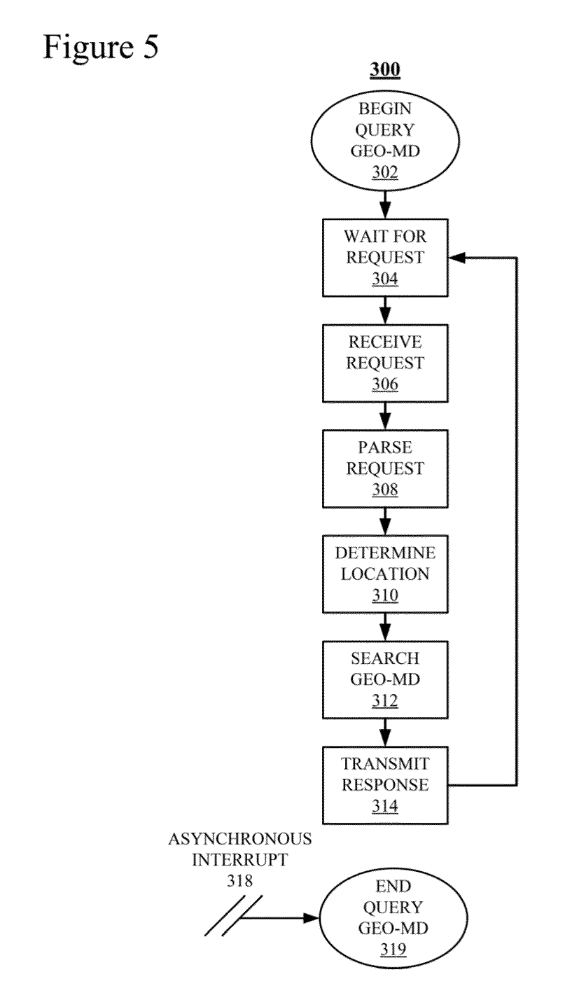

During processing associated with a “More Locations” block 264, a determination is made as to whether or not there are more locations to process. If so, control returns to block 256, the next unprocessed location is retrieved and processing continues as described above. In the alternative, to the batch processing of geo-metadata suggested by process 250, the data may also be analyzed on an “ad hoc” basis. For example, once a query is received (see 300, FIG. 5) concerning a particular location and question, the stored geo-metadata may be queried and analyzed then to determine an appropriate response. If a determination during processing associated with block 264 that there are no more locations to process, control proceeds to an “End Organize Geo-MD” block 269 during, which process 250 is complete.

FIG. 5 is an example of a flowchart of a Query Geo-metadata process 300 that may implement aspects of the claimed subject matter. In this example, process 300 is associated with logic stored on CRSM 112 (FIG. 1) in conjunction with GMGO 114 (FIGS. 1 and 2) and executed on one or more processors (not shown) of CPU 104 (FIG. 1) of computing system 102 (FIG. 1).

Process 300 starts in to “Begin Query Geo-Metadata (GEO-MD)” block 302 and proceeds immediately to a “Wait for Request” block 304. During processing associated with block 304, GMGO 114 is in a paused, or wait, state and ready to receive a request from a user for information. Once such a request is received, control proceeds to a “Receive Request” block 306. During processing associated with block 306, a request for location information in accordance with the disclosed technology is received. During processing associated with a “Parse Request” block 308, the request received during processing associated with block 306 is parsed to determine exactly what information is being requested and the corresponding search parameters will enable GMGO 114 to locate the requested information. In other words, the mature of the request is determined and categorized according to the type of information requested and appropriate search parameters are generated. For example, a user may be requesting the average length of time spent by patrons of one or a number of restaurants.

During processing associated with a “Determine Location” block 310, the location that the request received during processing associated with block 306 is determined based upon data transmitted with the request. The location corresponding to a request may be used to determine the distance corresponding to locations for which information is returned to a user in response to a request for data. During processing associated with a “Search Geo-Metadata” block 312, geo-metadata 156 (FIG. 2) is searched based upon search parameters generated during processing associated with block 308. During processing associated with a “Transmit Response” block 314, the results of the search conducted during processing associated with block 312 are transmitted to the user that transmitted the request received during processing associated with block 306.

Finally, process 300 is halted by means of an asynchronous interrupt 318, which passes control to an “End Query Geo-MD” block 319 in which process 300 is complete. Interrupt 318 is typically generated when the OS, browser, application, etc. of which process 300 is a part is itself halted. During normal operation, process 300 continuously loops through the blocks 304, 306, 308, 310, 312 and 314, processing requests from users as the requests are received.

The terminology used herein is for the purpose of describing particular embodiments only and is not intended to be limiting of the invention. As used herein, the singular terms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

We claim:

1. A method, comprising:
gathering geo-metadata corresponding to a plurality of locations;
correlating each datum of the geo-metadata with a particular location of the plurality of locations;
storing in conjunction with each particular datum information identifying the particular location correlated to each particular datum to produce a location/geo-metadata information source; and
mining the geo-metadata information source to generate a plurality of patterns associated with the plurality of locations; and
searching the plurality of patterns in response to a query for information to produce an answer to the query.

2. The method of claim 1, wherein the locations correspond to one or more of a list, the list consisting of:
businesses;
restaurants;
geographical locations;
public places;
coffee shops; and
movie theaters.

3. The method of claim 1, the gathering comprising collecting the geo-metadata from a plurality of mobile computing devices.

4. The method of claim 3, the plurality of mobile computing devices comprising any number of computing devices from a list of computing devices, the list comprising:
mobile telephones;
cameras;
video cameras;
laptop computers;
tablet computers; and
global positioning system (GPS) devices.

5. The method of claim 1, wherein the plurality of patterns are from a list of patterns, the list consisting of:
length of time spent at a location; and
time of day at which a datum was collected; and
day of week at which a datum was collected.

6. The method of claim 1, wherein information identifying the particular location is a reference to a record in a remote database.

7. The method of claim 1, further comprising normalizing the geo-metadata.

8. An apparatus, comprising:
a plurality of processors;
a non-transitory, computer-readable storage medium coupled to the plurality of processors; and
logic, stored on the computer-readable storage medium and executed on the plurality of processors, for:
gathering geo-metadata corresponding to a plurality of locations;
correlating each datum of the geo-metadata with a particular location of the plurality of locations;
storing in conjunction with each particular datum information identifying the particular location correlated to each particular datum to produce a location/geo-metadata information source; and
mining the geo-metadata information source to generate a plurality of patterns associated with the plurality of locations; and
searching the plurality of patterns in response to a query for information to produce an answer to the query.

9. The apparatus of claim 8, wherein the locations correspond to one or more of a list, the list consisting of:
businesses;
restaurants;
geographical locations;
public places;
coffee shops; and
movie theaters.

10. The apparatus of claim 8, the logic for gathering comprising logic for collecting the geo-metadata from a plurality of mobile computing devices.

11. The apparatus of claim 10, the plurality of mobile computing devices comprising any number of computing devices from a list of computing devices, the list comprising:
mobile telephones;
cameras;
video cameras;
laptop computers;
tablet computers; and
global positioning system (GPS) devices.

12. The apparatus of claim 8, wherein the plurality of patterns are from a list of patterns, the list consisting of:
length of time spent at a location; and
time of day at which a datum was collected; and
day of week at which a datum was collected.

13. The apparatus of claim 8, wherein information identifying the particular location is a reference to a record in a remote database.

14. The apparatus of claim 8, the logic further comprising logic for normalizing the geo-metadata.

15. A computer programming product, comprising:
a non-transitory, computer-readable storage medium; and
logic, stored on the computer-readable storage medium and executed on the plurality of processors, for:
gathering geo-metadata corresponding to a plurality of locations;
correlating each datum of the geo-metadata with a particular location of the plurality of locations;
storing in conjunction with each particular datum information identifying the particular location correlated to each particular datum to produce a location/geo-metadata information source; and
mining the geo-metadata information source to generate a plurality of patterns associated with the plurality of locations; and
searching the plurality of patterns in response to a query for information to produce an answer to the query.

16. The computer programming product of claim 15, wherein the locations correspond to one or more of a list, the list consisting of:
businesses;
restaurants;
geographical locations;
public places;
coffee shops; and
movie theaters.

17. The computer programming product of claim 15, the logic for gathering comprising logic for collecting the geo-metadata from a plurality of mobile computing devices.

18. The computer programming product of claim 17, the plurality of mobile computing devices comprising any number of computing devices from a list of computing devices, the list comprising:
mobile telephones;
cameras;
video cameras;
laptop computers;
tablet computers; and
global positioning system (UPS) devices.

19. The computer programming product of claim 15, wherein the plurality of patterns are from a list of patterns, the list consisting of:
length of time spent at a location; and
time of day at which a datum was collected; and
day of week at which a datum was collected.

20. The computer programming product of claim 15, wherein information identifying the particular location is a reference to a record in a remote database.
